(19) United States
(12) Patent Application Publication
(10) Pub. No.: US 2010/0312561 A1
(43) Pub. Date: Dec. 9, 2010

(54) Information Processing Apparatus, Information Processing Method, and Computer Program

(76) Inventor: Ugo Di Profio, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/745,464

(22) PCT Filed: Dec. 4, 2008
(86) PCT No.: PCT/JP2008/072061

§ 371 Date: May 28, 2010

(30) Foreign Application Priority Data
Dec. 7, 2007 (JP) 2007-317713
Jun. 11, 2008 (JP) 2008-153482
Dec. 2, 2008 (JP) 2008-307076

(51) Int. Cl. G10L 15/14

(52) U.S. Cl. 704/256; 704/E15.004

(57) ABSTRACT

An apparatus and a method for performing a grounding process using the POMDP are provided. The configuration is designed so that, in order to understand a request from a user through the utterances from the user, a grounding process is performed using the POMDP (Partially Observable Markov Decision Process) in which analysis information acquired from a language analyzing unit that receives the utterances of the user and performs language analysis and pragmatic information including task feasibility information acquired from the task manager that performs a task are set as observation information. Accordingly, understanding can be efficiently achieved, and high-speed and accurate recognition of the user request and task execution based on the user request can be provided.

### TECHNICAL FIELD

The present invention relates to an information processing apparatus, an information processing method, and a computer program and, in particular, to an information processing method, and a computer program applied to a configuration for performing processing through communication between, for example, a user and the information processing apparatus (e.g., a television set) and, more particularly, to a configuration in which the information processing apparatus analyzes an utterance from the user and performs a task requested by the user.

Furthermore, the present invention relates to an information processing apparatus, an information processing method, and a computer program that perform a grounding process in order for a system to correctly recognize the user's intention using a POMDP (partially observable Markov decision process).

### BACKGROUND ART

For example, a variety of researches have been conducted for a configuration in which a system, such as a television set, recognizes an utterance output from a user and performs processing without using a remote controller. In order for a system to understand the words of the user and perform correct processing, common understanding between the user and the system is needed.

For example, if the system cannot understand a user request, the system needs to solve the problem by asking the user a question to and correctly understanding the user's intention using the answer from the user.

In order to communicate with a user, the system mainly performs the following two processes:

a process performed inside the system in response to a user request (e.g., in the case of the system being a television set, a process performed inside the system to change a channel in response to a user request) (referred to as a “domain task”); and

a process to achieve mutual understanding between the system and the user through discourse in which, if the system cannot understand the user request, the system asks the user a question and uses the answer (referred to as a “discourse task”).

For example, in conversation among persons, the processing performed in order for the persons to understand each other is referred to as “grounding”. In the grounding, the following processes need to be performed:

(1) a process to confirm whether mutual understanding has been achieved; and

(2) a process performed in order to achieve mutual understanding.

(1) In order to confirm whether mutual understanding has been achieved, a criterion for determining whether understanding has been achieved is needed. For example, the belief of understanding or an index for measuring satisfaction is needed. In addition, the levels of the criteria needs to be the same for a speaker and a listener.

(2) In a process to achieve mutual understanding, that is, in a grounding process, it is important to standardize an index for measuring the effectiveness of conversation or communication between the users and a grounding act.

An existing technique regarding a process to achieve mutual understanding, that is, a grounding process, is described in Non-Patent Document 1 (David R. Traum and James F. Allen. A speech acts approach to grounding in conversation. In Proceedings 2nd International Conference on Spoken Language Processing (ICSLP-92), pages 137-40, October 1992).

The configuration shown in this Non-Patent Document is described with reference to FIGS. 1 and 2. As shown in FIG. 1, this Non-Patent Document describes, for example, a state transition structure applied to a communication process performed among a plurality of persons. In a communication process, as shown in FIG. 1, the following seven states appear:
S. initial state,
1. state immediately after initiation,
2. system confusion state,
3. confirmation needed state,
4. user confusion state,
F. grounding state, and
D. cancel state.

In a communication process, transitions among these seven states occur.

In Non-Patent Document 1, a correspondence between the current state corresponding to the state transition and an action that causes a state transition is defined as shown in the table of FIG. 2. FIG. 2 indicates the next states it is possible to transition to when the next action shown in the table (i.e., Initiate(I) to cancel(R)) is performed in the current state (S to D).

For example, in an initial state (S), an action initiator (Initiater) performs some action. For example, a first user becomes the action initiator, and the first user makes an utterance. In such a case, the state changes from (S) to (1). Furthermore, when the action initiator (Initiater) continues to make utterances in state (1), the state continues to be (1) or changes from state (1) to state (4).

If the state changes to grounding state “F”, it is determined that a plurality of persons making conversation reach a mutually understanding state. Cancel “D” is a state in which the users fail to reach mutual understanding.

In Non-Patent Document 1, a process in which persons mutually understand in communication, that is, a grounding process is mainly described. Such a mutual understanding process (a grounding process) is also necessary for communication between a person and a system. That is, when a user requests a system (e.g., a television set) to perform processing, it is necessary for the user and system to reach mutual understanding in order that correct processing is performed.

Non-Patent Document 1: David R. Traum and James F. Allen. A speech acts approach to grounding in conversation. In Proceedings 2nd International Conference on Spoken Language Processing (ICSLP-92), pages 137-40, October 1992

### DISCLOSURE OF INVENTION

### Technical Problem

To solve the above-described problems, it is an object of the invention to provide an information processing apparatus, an information processing method, and a computer program that allow a system to achieve mutual understanding in communication with a user and effectively perform correct processing.

It is another object of the invention to provide an information processing apparatus, an information processing method, and a computer program that allow a system, such as a television set, that interprets an utterance from a user to correctly recognize the user's intention using a POMDP (Partially Observable Markov Decision Process) and perform the processing.

### Technical Solution

According to a first aspect of the present invention, an information processing apparatus for receiving an utterance from a user and analyzing the utterance is provided. The information processing apparatus is characterized by including a user interface that receives an utterance from a user and performs language analysis, a discourse manager that receives a recognition result of information regarding the user utterance input via the user interface and performs a grounding process for understanding a user request by using a Partially Observable Markov Decision Process (POMDP), and a task manager that executes a task on the basis of information regarding a result of the grounding process performed by the discourse manager.

According to an embodiment of the present invention, the information processing apparatus is characterized by further including a display that displays a system action for the user during the grounding process performed by the discourse manager.

According to another embodiment of the present invention, the information processing apparatus is characterized in that the discourse manager has a configuration so as to perform a grounding process using the POMDP in which semantic information generated from the utterance from the user and pragmatic information generated on the basis of information including feasibility of a task performed by the task manager are set as Observation space.

According to still another embodiment of the present invention, the information processing apparatus is characterized in that the discourse manager has a configuration so as to perform a grounding process using the POMDP in which a state value computed using the semantic information serving as an observation space and a state value computed using the pragmatic information serving as Observation space are set as State space.

According to yet still another embodiment of the present invention, the information processing apparatus is characterized in that the discourse manager has a configuration so as to perform a grounding process using the POMDP in which a state value computed using the semantic information serving as Observation space, a state value computed using the pragmatic information serving as Observation space, and a state value computed using another observation space are set as State space.

According to yet still another embodiment of the present invention, the information processing apparatus is characterized in that the discourse manager has a configuration so as to perform a grounding process using the POMDP having a configuration in which a cost is computed on the basis of State space including a state value computed using the semantic information serving as Observation space and a state value computed using the pragmatic information serving as Observation space.

According to yet still another embodiment of the present invention, the information processing apparatus is characterized in that the discourse manager has a configuration so as to perform a grounding process using the POMDP in which a user action including the utterance from the user is set as Observation space.

According to yet still another embodiment of the present invention, the information processing apparatus is characterized in that the discourse manager has a configuration so as to perform a grounding process using the POMDP in which a state value computed using the user action serving as Observation space is set as State space.

Furthermore, according to a second aspect of the present invention, an information processing method for use in an information processing apparatus for receiving an utterance from a user and analyzing the utterance is provided. The method is characterized by including a language input and analysis step of receiving an utterance from a user and performing language analysis by using a user interface, a discourse management step of receiving a recognition result of information regarding the user utterance input via the user interface and performing a grounding process for understanding a user request by using a Partially Observable Markov Decision Process (POMDP) by using a discourse manager, and a task management step of executing a task on the basis of information regarding a result of the grounding process performed in the discourse management step by using a task manager.

According to yet still another embodiment of the present invention, the information processing method is characterized by further including a step of displaying a system action for the user during the grounding process performed in the discourse management step by using a display.

According to yet still another embodiment of the present invention, the information processing method is characterized in that the discourse management step is a step of performing a grounding process using the POMDP in which semantic information generated in response to the utterance from the user and pragmatic information generated on the basis of information including feasibility of a task performed by the task manager are set as Observation space.

According to yet still another embodiment of the present invention, the information processing method is characterized in that the discourse management step is a step of performing a grounding process using the POMDP in which a state value computed using the semantic information serving as an observation space and a state value computed using the pragmatic information serving as Observation space are set as State space.

According to yet still another embodiment of the present invention, the information processing method is characterized in that the discourse management step is a step of performing a grounding process using the POMDP in which a state value computed using the semantic information serving as Observation space, a state value computed using the pragmatic information serving as Observation space, and a state value computed using another observation space are set as State space.

According to yet still another embodiment of the present invention, the information processing method is characterized in that the discourse management step is a step of performing a grounding process using the POMDP having a configuration in which a cost is computed on the basis of State space including a state value computed using the semantic information serving as Observation space and a state value computed using the pragmatic information serving as Observation space.

According to yet still another embodiment of the present invention, the information processing method is characterized in that the discourse management step is a step of performing a grounding process using the POMDP in which a user action including the utterance from the user is set as Observation space.

According to yet still another embodiment of the present invention, the information processing method is characterized in that the discourse management step is a step of performing a grounding process using the POMDP in which a state value computed using the user action serving as Observation space is set as State space.

According to yet still another embodiment of the present invention, the information processing method is characterized in that the discourse management step is a step of performing a grounding process using the POMDP having a configuration in which a cost is computed on the basis of State space including a state value computed using the user action serving as Observation space.

According to yet still another embodiment of the present invention, the information processing method is characterized in that the discourse management step is a step of performing a process using a grounding model in which an Initiate process, a continue process, a repair process, a RegRepair process, an ack process, a Reqack process, and a cancel process are defined as executed actions of the grounding process.

According to yet still another embodiment of the present invention, the information processing method is characterized in that the discourse management step is a step of performing a process using a grounding model in which an Initiate process, an ack process, and a cancel process are defined as executed actions of the grounding process.

Furthermore, according to a third aspect of the present invention, a computer program for causing an information processing apparatus to perform information processing for receiving an utterance from a user and analyzing the utterance is provided. The computer program is characterized by including a language input and analysis step of receiving an utterance from a user and performing language analysis by using a user interface, a discourse management step of receiving a recognition result of information regarding the user utterance input via the user interface and performing a grounding process for understanding a user request by using a POMDP (Partially Observable Markov Decision Process) by using a discourse manager, and a task management step of executing a task on the basis of information regarding a result of the grounding process performed in the discourse management step by using a task manager.

It should be noted that the computer program according to the present invention is a computer program suppliable to, for example, general-purpose computers that can execute various program code using a computer-readable recording medium or communication medium. By providing such a program in a computer-readable format, a process in accordance with the program can be realized in a computer system.

Further features and advantages of the present invention will become apparent from the following detailed description of exemplary embodiments with reference to the attached drawings. In addition, it should be noted that, in the present specification, the term “system” refers to a logical combination of a plurality of devices; the plurality of devices is not necessarily included in one body.

### ADVANTAGEOUS EFFECTS

According to an embodiment of the present invention, the configuration is designed so that, in order to understand a request from a user through the utterances from the user, a grounding process is performed using the POMDP (Partially Observable Markov Decision Process) in which analysis information acquired from a language analyzing unit that receives the utterances of the user and performs language analysis and pragmatic information including task feasibility information acquired from the task manager that performs a task are set as observation information. Accordingly, understanding can be efficiently achieved, and high-speed and accurate recognition of the user request and task execution based on the user request can be provided.

### BRIEF DESCRIPTION OF DRAWINGS

FIG. 1 is a diagram illustrating an example of state transition in a grounding process.

FIG. 2 is a diagram illustrating an example of a correspondence between an action and state transition in a grounding process.

FIG. 3 is a diagram illustrating an example of a process to which the POMDP (Partially Observable Markov Decision Process) is applied.

FIG. 4 is a diagram illustrating the configuration of an information processing apparatus according to an embodiment of the present invention and the processing performed by the information processing apparatus.

FIG. 5 is a flowchart illustrating a process performed by a discourse manager of an information processing apparatus according to an embodiment of the present invention.

FIG. 6 is a flowchart illustrating a process performed by a discourse manager of an information processing apparatus according to an embodiment of the present invention.

FIG. 7 is a flowchart illustrating a process performed by a POMDP execution unit of a discourse manager of an information processing apparatus according to an embodiment of the present invention.

FIG. 8 is a diagram illustrating a POMDP application process performed by a discourse manager of an information processing apparatus according to an embodiment of the present invention.

FIG. 9 is a diagram illustrating a Bayesian network and a conditional probability table (CPT).

FIG. 10 is a diagram illustrating an example of transition of state value data in accordance with a change in State space set in the POMDP as time passes.

FIG. 11 is a diagram illustrating an example of transition of state value data in accordance with a change in State space set in the POMDP as time passes.

FIG. 12 is a diagram illustrating a result of comparison of the grounding processes in the POMDP application process performed by the information processing apparatus according to the present invention and another process.

FIG. 13 is a diagram illustrating a result of comparison of the grounding processes in the POMDP application process performed by the information processing apparatus according to the present invention and another process.

FIG. 14 is a diagram illustrating an example of the grounding process using the POMDP performed by the information processing apparatus according to the present invention.

FIG. 15 is a diagram illustrating an example of the grounding process using the POMDP performed by the information processing apparatus according to the present invention.

FIG. 16 is a diagram illustrating an example of the grounding process using the POMDP performed by the information processing apparatus according to the present invention.

FIG. 17 is a diagram illustrating an example of the grounding process using the POMDP performed by the information processing apparatus according to the present invention.

FIG. 18 is a diagram illustrating an exemplary configuration of the information processing apparatus according to the present invention.

FIG. 19 is a diagram illustrating an exemplary hardware configuration of the information processing apparatus according to the present invention.

### BEST MODES FOR CARRYING OUT THE INVENTION

An information processing apparatus, an information processing method, and a computer program according to an embodiment of the present invention are described in detail below with reference to the accompanying drawings. Note that the descriptions are made in the following order:

(1) Outline of Processing Performed by Information Processing Apparatus According to Invention

(2) Exemplary Configuration and Detailed Processing of Information Processing Apparatus According to Invention

(3) Detailed Grounding Process Performed by Discourse Manager

(4) Exemplary Grounding Process using POMDP

(5) Exemplary Hardware Configuration of Information Processing Apparatus

[(1) Outline of Processing Performed by Information Processing Apparatus According to Invention]

According to the present invention, an example of the information processing apparatus is a system, such as a television set, that performs a variety of processes (e.g., channel selection) in accordance with an utterance from a user. That is, through system and user communication, the information processing apparatus performs a process that the user intends. In order to understand the user's intention correctly, the information processing apparatus performs a process to achieve mutual understanding with the user, that is, a grounding process.

According to an embodiment of the present invention, in the grounding process, the information processing apparatus employs the following techniques:

(1) BN (Bayesian Network), and

(2) POMDP (Partially Observable Markov Decision Process).

The BN (Bayesian Network) includes a plurality of nodes, and the relationship among the nodes is defined. For example, the process to generate a Bayesian network and a process to user the Bayesian network are described in U.S. Patent published application Nos. 2004/0220892 and 2002/0103793. These documents describe a process to generate a reliable Bayesian network in which the relationship among nodes is correctly defined. According to the present invention, the information processing apparatus uses a Bayesian network in order to estimate the level of mutual understanding and perform tracking. For example, the information processing apparatus performs a process using data acquired through speech recognition of an utterance from a user, language processing, semantic analysis, and understanding of words.

The POMDP (Partially Observable Markov Decision Process) is known as one of techniques used for state prediction or action decision. The partially observable Markov decision process (hereinafter referred to as a “POMDP”) is schematically described next.

The POMDP is a technique used for state prediction or action decision by using the following information:

(a) state apace (S),

(b) action space (A),

(c) observation space (O), and

(d) reward space (R).

Such information changes as time (t) passes. For example, a function of computing state transition probability, a function of computing reward, and a function of computing the probability of occurrence of an observation state are defined. Thereafter, state prediction or action decision is performed using obtainable information and the defined functions.

Examples of the defined functions include the following functions:

a state transition probability computing function T(sₜ, aₜ₋₁, sₜ₋₁)=P (sₜ|aₜ₋₁, sₜ₋₁) used for computing the probability of a state transition to a state S=sₜ at the next time T=(t) when a state S=sₜ₋₁ and an action A=at a time T=(t−1),

a reward function R(Sₜ, aₜ) used for computing a reward using state S=sₜ and an action A=aₜ at a time T=(t), and

an observation state probability function O(sₜ, aₜ₋₁, oₜ₋₁)=P(oₜ|aₜ₋₁, sₜ) used for computing the probability of occurrence of an observation state at a time T=(t) using an action A=aₜ₋₁ at a time T=(t−1) and a state S=sₜ at a time T=(t).

The POMDP is a technique used for state prediction or action decision by using the above-described various information and functions. For example, the POMDP is applied to a process for determining an optimal action from a small amount of obtainable information. More specifically, the POMDP is applicable to a variety of action decision processes, such as a process for determining the action of a robot, simulation using a computer, data processing, and a process for determining an optimal human action in business.

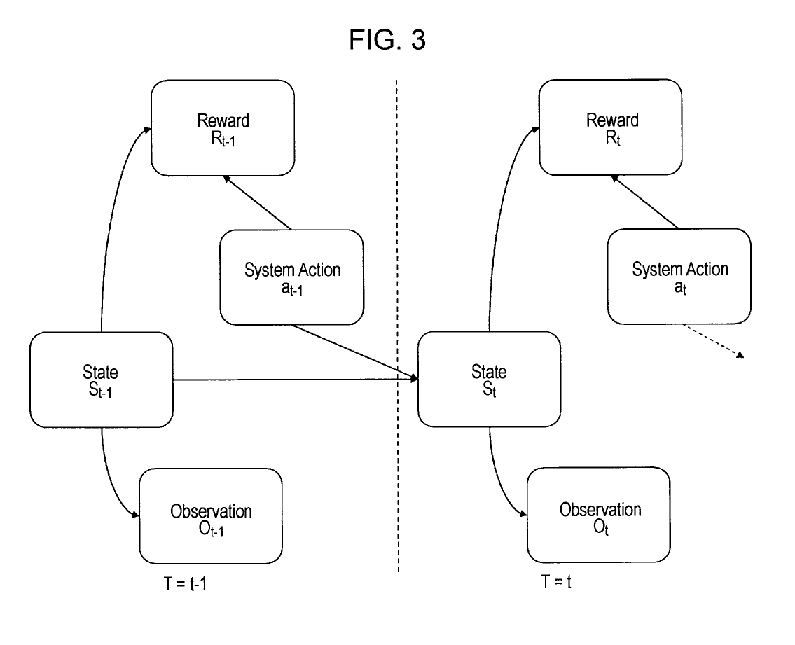

State prediction or action decision by using the POMDP and the above-described various information is described next with reference to FIG. 3. FIG. 3 illustrates a state sₜ₋₁, an action aₜ₋₁, a reward Rₜ₋₁, and an observation oₜ₋₁ at a time T=(t−1) and a state S=sₜ, an action aₜ, a reward Rₜ, and an observation oₜ at the next time T=(t). Arrows connecting the blocks represent effects between the blocks. That is, the information on a source (a parent) of an arrow may change the state or information of the destination (a child) of the arrow.

For example, as described above, at a time T=t−1, a reward Rₜ₋₁ can be obtained using the state sₜ₋₁ and the action aₜ₋ₗ, at a time T=t−1 and the reward function R(sₜ₋₁), aₜ₋₁).

In addition, the observation information oₜ₋₁ is observable information that changes as, for example, the state sₜ₋₁ changes.

This relationship is also applied to any time T=t−1, t, t+1, . . . .

Furthermore, at different times, a relationship between a state sₜ at a time T=t and a combination of a state sₜ₋₁ and an action aₜ₋₁ at a time T=t−1 is defined by the above-described state transition probability computing function T (sₜ, aₜ₋₁, sₜ₋₁)=P (sₜ|aₜ₋₁, sₜ₋₁). That is, the probability of occurrence of state sₜ at a time T=t can be computed using a state sₜ₋₁ and an action aₜ₋₁ at the previous time T=t−1. This relationship can be applied to the entire period of the continuous event observation times.

In this way, according to the POMDP, in a target area including uncertainty, various information items (a state, an action, a reward, and an observation) are defined. Thereafter, using a relationship among the information items, state transition is estimated or an action of a person is decided in the target area including uncertainty. For example, in an action decision process, an action for which a reward is maximized is considered as a best action.

Note that in a process for constructing a POMDP, it is important to properly set a relationship among the information items (a state, an action, a reward, and an observation). In such a process, a Bayesian network (BN) can be employed.

According to an embodiment of the present invention, the information processing apparatus employs a POMDP in order to make a model of a grounding process and perform a tracking process for a discourse performed between a user and an apparatus, that is, in order to construct a particular grounding process.

In addition, according to the embodiment of the present invention, the information processing apparatus employs a rule for performing grounding in discourse. For example, a rule for generating a question in order to achieve clear understanding for an instruction received from a user is employed.

For example, the following process is performed:

User: I need a flight to London

Upon receiving such a request, the system performs the following confirmation process in order to achieve mutual understanding:

System: Did you say “to London”?

The system asks such a question to make confirmation. The user replies to the question as follows:

User: Yes

By acquiring such an answer, a confidence P of understanding can be increased.

In this way, [confidence(P)] of London being a destination can be increased by the user response (Yes).

In such a case, the confidence P is expressed as follows:

P(Destination=London|Evidence=Yes).

[(2) Exemplary Configuration and Detailed Processing of Information Processing Apparatus According to Invention]

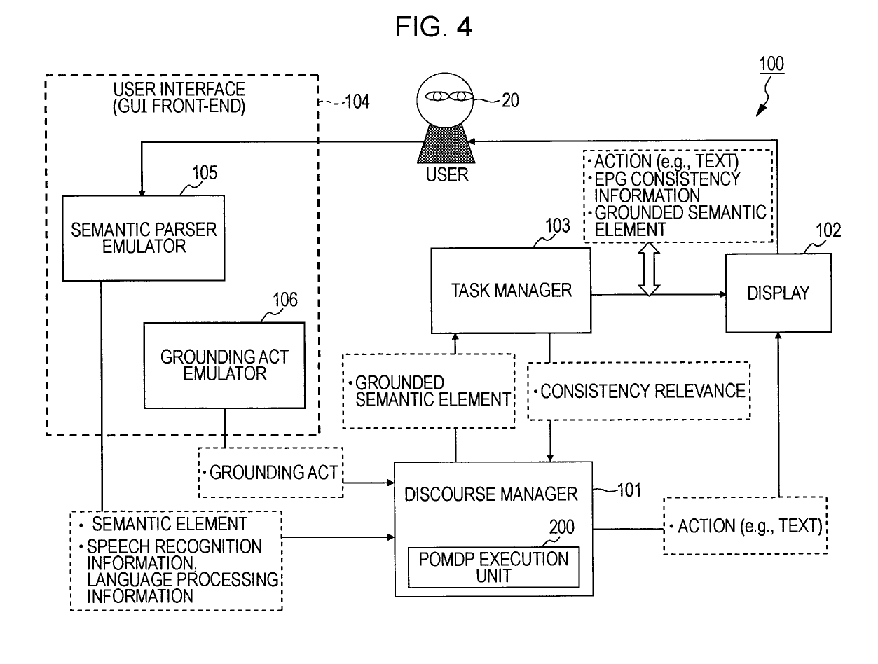

FIG. 4 illustrates an exemplary configuration of the information processing apparatus according to the present invention. In FIG. 4, as an example, a television system that performs processing, such as channel selection, is illustrated. The television set includes a data processing unit that performs communication with a user. The data processing unit performs a mutual understanding process using the POMDP and a Bayesian network, that is, a grounding process.

As shown in FIG. 4, an information processing apparatus 100 includes a discourse manager 101, a display 102, a task manager 103, and a user interface (a GUI front-end) 104. The user interface (the GUI front-end) 104 includes a semantic parser emulator 105, and a grounding act emulator 106. The discourse manager 101 includes a POMDP execution unit 200. The POMDP execution unit 200 executes a grounding process using the partially observable Markov decision process (POMDP).

Existing speech recognition and semantic analysis are performed on an utterance output from a user 20 in the semantic parser emulator 105 of the user interface (the GUI front-end) 104. Thus, the meaning of the utterance is recognized. The recognized words are output to the discourse manager 101.

In addition, when a grounding process is performed, the words output from the user are input to the grounding act emulator 106. The action of the user and the utterance information processed in the grounding process, that is, in the mutual understanding process between the user 20 and the information processing apparatus 100 are extracted as Grounding Act. Thereafter, the grounding act is output to the discourse manager 101 together with the user utterance information.

If the meaning of the words of the user is sufficiently recognized by the semantic parser emulator 105, the discourse manager 101 outputs a task execution request to the task manager 103. More specifically, the discourse manager 101 outputs a semantic element, such as information regarding a channel change instruction or a request for displaying a program listing (an EPG). The task manager 103 performs a task corresponding to a request input from the discourse manager 101. The result of the task execution is output to, for example, the display 102.

Note that the task manager 103 sends task information regarding task information allowable for the discourse manager 101.

However, if the meaning of the words of the user is not sufficiently recognized by the semantic parser emulator 105, a ground process is performed in the following manner. The grounding act emulator 106 extracts the action of the user and the utterance information as a grounding act, which is then output to the discourse manager 101 together with the user utterance information.

The discourse manager 101 performs a grounding process in response to the input of information from the grounding act emulator 106. That is, the discourse manager 101 performs a grounding process for achieving mutual understanding with the user. In this grounding process, the POMDP is used.

For example, in the grounding process, a question is displayed on the display 102. The answer to the question is input by the user 20 via the user interface (the GUI front-end) 104. The semantic parser emulator 105 performs language analysis including speech recognition and semantic analysis, and the grounding act emulator 106 extracts a grounding act. The result of the processes is input to the discourse manager 101. In the grounding process, such processes are repeated.

If the meaning of the words output from the user is finally recognized through the grounding process performed by the discourse manager 101 using the POMDP, the discourse manager 101 outputs a task execution request to the task manager 103. More specifically, for example, the discourse manager 101 outputs a semantic element, such as channel change instruction information or a request for displaying a program guide (an EPG). The task manager 103 executes a task corresponding to the request input from the discourse manager 101. The result of the task execution is output to the display 102.

[(3) Detailed Grounding Process Performed by Discourse Manager]

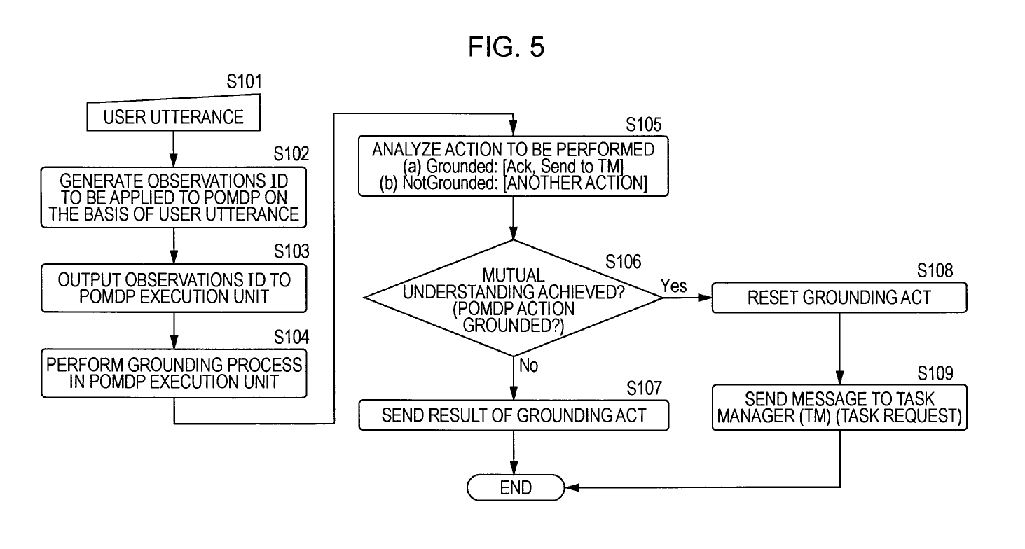

A sequence of a grounding process performed by the discourse manager 101 is described in detail below with reference to the flowcharts illustrated in FIGS. 5 to 7.

FIG. 5 is a flowchart of a whole sequence of a grounding process performed by the discourse manager 101.

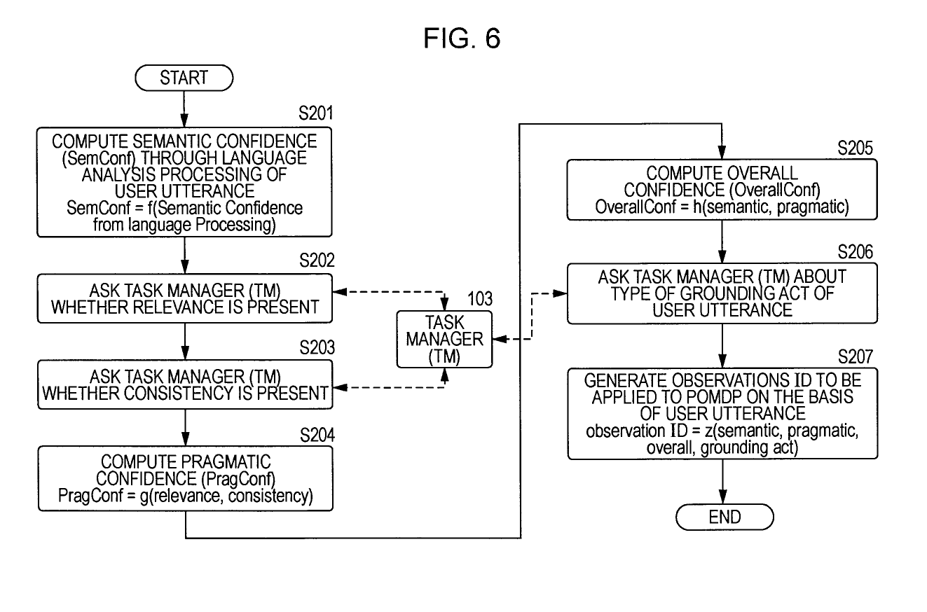

FIG. 6 is a flowchart of a process performed in step S102 shown in FIG. 5, that is, a detailed sequence of a process for generating an observation value (an observations ID) applied to the POMDP on the basis of the user utterance.

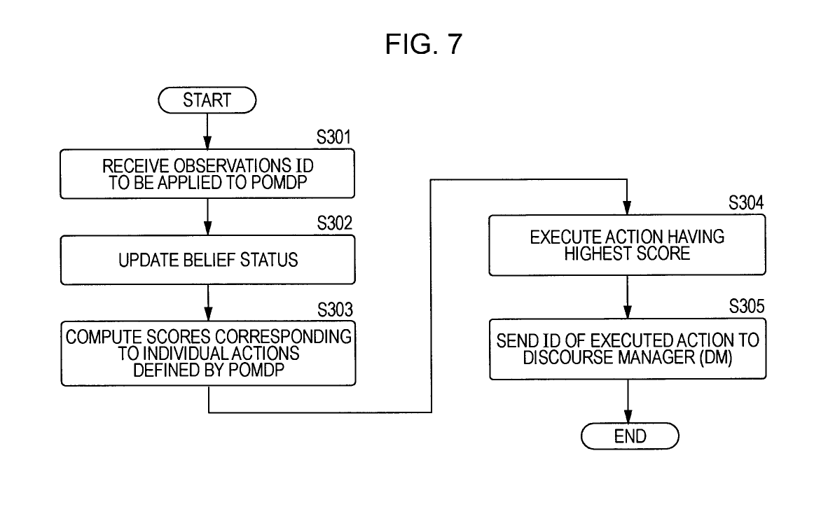

FIG. 7 is a flowchart of a process performed in step S104 shown in FIG. 5, that is, a detailed sequence of a grounding process performed by the POMDP execution unit 200. The POMDP execution unit 200 performs a grounding process using a partially observable Markov decision process (POMDP).

The processes performed in steps of the flowchart shown in FIG. 5 are described next.

First, a user utterance is produced in step S101. The user utterance information is input to the discourse manager 101 via the user interface (the GUI front-end) 104 shown in FIG. 4.

Subsequently, in step S102, the discourse manager 101 generates an observations ID on the basis of the user utterance.

The process performed in step S102 is described in detail below with reference to the flowchart shown in FIG. 6.

In step S201, the discourse manager 101 computes a belief of understanding for the user utterance input via the user interface 104 shown in FIG. 4. At that time, a belief of understanding is computed using only the information (the semantic information) based on the language analysis process. A semantic confidence [SemConf] from language processing obtained using only the information (the semantic information) based on the language analysis is computed as follows:

SemConf=f(semantic confidence from language processing),

where f( ) represents a function of computing a semantic confidence from language processing [SemConf] stored in the discourse manager 101.

Subsequently, in step S202, the discourse manager 101 inquires of the task manager 103 about the presence of relevance of the result of the language analysis of the user utterance input via the user interface (the GUI front-end) 104. The task manager 103 answers, to the discourse manager 101, the presence or absence of relevance of the result of the language analysis of the user utterance.

For example, when this process is performed by a television system and if the user utterance regarding an operation of the television system, such as channel change, is recognized, the task manager 103 returns a determination result indicating the presence of relevance. However, if a user utterance that is not related to an operation of the television system (e.g., an utterance “I′m tired”) is recognized, the task manager 103 returns a determination result indicating the absence of relevance. Note that the task manager 103 has a program for making such determination and makes the determination using the program.

Subsequently, in step S203, the discourse manager 101 inquires of the task manager 103 about the presence of the consistency of the user utterance input via the user interface 104. The task manager 103 answers, to the discourse manager 101, the presence or absence of consistency of the user utterance.

For example, if the task manager 103 has already been processing a request from the user, the task manager 103 determines whether a user utterance representing the next instruction has a consistency with the current processing. Note that the task manager 103 has a program for determining the relevance and the consistency of the result of language analysis of a user utterance and make a determination using the program.

Subsequently, in step S204, the discourse manager 101 computes the confidence of understanding for pragmatic opinion using the information received from the task manager 103 (i.e., pragmatic opinion). The expression for computing the pragmatic confidence [PragConf] representing the confidence of understanding for pragmatic opinion is given as follows:

PragConf=g(relevance, consistency)

where g( ) represents a function of computing the pragmatic confidence [PragConf] stored in the discourse manager 101.

Subsequently, in step S205, the discourse manager 101 computes an overall confidence [OverallConf] by summing the semantic confidence from language processing [SemConf] obtained using only the information (the semantic information) based on the language analysis performed in step S201 and the pragmatic confidence [PragConf] representing the confidence of understanding computed using pragmatic information in step S204. The expression for computing the overall confidence [OverallConf] is given as follows:

OverallConf=h(semantic, pragmatic)

where h( ) represents a function of computing the overall confidence [OverallConf] stored in the discourse manager 101.

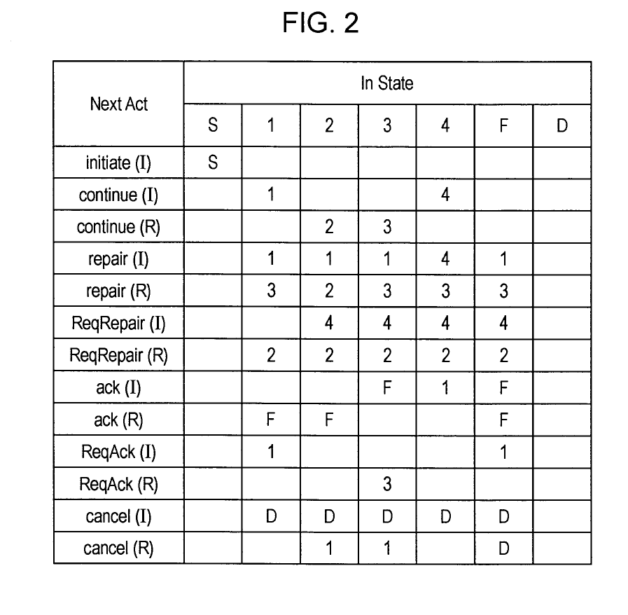

Subsequently, in step S206, the discourse manager 101 inquires of the task manager 103 about the type (category) of the grounding act of the user utterance input through the user interface 104. That is, the discourse manager 101 inquires of the task manager 103 which one of categories Initiate(I) to cancel(R) shown in FIG. 2 the user utterance belongs to. The task manager 103 analyzes the action of the user utterance using the prestored program and notifies, as a result of the analysis, the discourse manager 101 of which one of the grounding acts the user utterance is.

In step S207, the discourse manager 101 generates an observations ID to be applied to the POMDP. The observations ID corresponds to the input user utterance. The observations ID is computed using the following values:

(a) a semantic confidence [SemConf] computed in step S201 and obtained from only information based on language analysis processing,

(b) a pragmatic confidence [PragConf] computed using pragmatic information in step S204,

(c) an overall confidence computed in step S205, and

(d) grounding act information regarding the user utterance acquired from the task manager 103 in step S206.

The discourse manager 101 determines an observations ID using these values and a predetermined computation program.

An expression for determining the observations ID is given as follows:

observations ID=z(semantic, pragmatic, overall, grounding act),

where z( ) represents a function of computing the observations ID stored in the discourse manager 101.

For example, each of the semantic confidence [SemConf], the pragmatic confidence [PragConf], and the overall confidence [OverallConf] is set to one of the following three values: a high confidence value [H(High)], a low confidence value [L(Low)], and a medium confidence value [A(Ambiguous)].

In addition, the grounding act of the user utterance is one of Initiate(I) to cancel(R) shown in FIG. 2 (thirteen types in the example shown in FIG. 2).

As a result, 3×3×3×13 different combination patterns appear.

The discourse manager 101 stores an observations ID and the corresponding data for each of these combination patterns and computes the observations ID on the basis of the corresponding data.

In this way, through the processes performed in steps S201 to S207 of the flow shown in FIG. 6, the discourse manager 101 generates the observations ID applied to the POMDP. The observations ID corresponds to the input user utterance.

Referring back to FIG. 5, the sequence of processes of the discourse manager 101 is continuously described. In step S102, the discourse manager 101 performs the processes in steps S201 to S207 of the flow shown in FIG. 6 and generates an observations ID corresponding to the user utterance.

Subsequently, in step S103, the discourse manager 101 outputs, to the POMDP execution unit 200, the observations ID corresponding to the user utterance. In the next step S104, a grounding process is performed by the POMDP execution unit 200. The grounding process performed by the POMDP execution unit 200 is described in more detail below with reference to a flowchart shown in FIG. 7.

In step S301, the POMDP execution unit 200 receives the observations ID corresponding to the user utterance. Subsequently, in step S302, the POMDP execution unit 200 performs a process of updating a belief status on the basis of the observations ID corresponding to the user utterance.

As described earlier, in the POMDP, the belief status is updated on the basis of the observations ID. For example, as described above, through the following process, the confidence P is increased.

User: I need a flight to London.

Upon receiving such a request, the system performs the following confirmation process in order to achieve mutual understanding:

System: Did you say “to London”?

The user replies to the question as follows:

User: Yes

Thus, the [Confidence(P)] of the destination being London can be increased by the reply (yes) from the user.

In this case, the confidence P is expressed as follows:

P(Destination=London|Evidence=Yes)

In step S302, a process that is similar to the above-described process is performed. Thus, the belief status is updated on the basis of the observations ID corresponding to the user utterance.

Subsequently, in step S303, the next action performed by the apparatus for the user is determined. For example, the action is one of Initiate(I) to cancel(R) shown in FIG. 2 (thirteen actions in the example shown in FIG. 2).

As described earlier, the POMDP is a technique used for state prediction or action decision by using the following information:

(a) state apace (S),

(b) action space (A),

(c) observation space (O), and

(d) reward space (R).

Such information changes as time (t) passes. For example, a function of computing the probability of a state transition, a function of computing a reward, and a function of computing the probability of occurrence of an observation state are defined. Thereafter, state prediction or action decision is performed using obtainable information and the defined functions.

Here, in step S301, a new observations ID corresponding to the user utterance is acquired. Thereafter, the next action is determined using the observations ID and a predefined algorithm. For example, a reward obtained when each of Initiate(I) to cancel(R) shown in FIG. 2 is computed. Note that in such a case, the reward corresponds to, for example, the belief of understanding.

In step S304, the rewards (=the belief of understanding) computed for the actions in step S303 are compared with each other, and an action having the highest value is selected as an action to be performed. Thereafter, the POMDP execution unit 200 executes the action as an action performed by the apparatus.

Subsequently, in step S305, the POMDP execution unit 200 sends an action ID serving as an identification of the executed action to the discourse manager 101.

Referring back to FIG. 5, the sequence of processes of the discourse manager 101 is continuously described. In step S104, the POMDP execution unit 200 performs a grounding process by performing the processes in steps S301 to S307 of the flow shown in FIG. 7. That is, the POMDP execution unit 200 determines an action to be performed by the apparatus and performs the determined action. Thereafter, the action ID of the action performed by the apparatus is sent to the discourse manager 101.

In step S105, the discourse manager 101 analyzes the progress of grounding, that is, the progress of mutual understanding using the action ID of the action performed by the apparatus. More specifically, if the action performed by the apparatus is one of the following actions:

(a) [Ack] representing a positive reply of understanding, and

(b) [Send to TM] representing sending a request for the processing to be performed by the task manager,

it is determined that grounding, that is, mutual understanding is achieved (grounded).

However, if the action performed by the apparatus is an action other than (a) [Ack] and (b) [Send to TM], it is determined that grounding, that is, mutual understanding is not achieved (not grounded).

If it is determined that grounding, that is, mutual understanding is achieved (grounded), the determination in step S106 results in “Yes”. At that time, the processing proceeds to step S108.

In step S108, the grounding act is reset. In step S109, a message (a task request) is sent to the task manager (TM).

However, if it is determined that grounding, that is, mutual understanding is not achieved (not grounded), the determination in step S106 results in “No”. At that time, the processing proceeds to step S107.

In step S107, the result of the grounding act, that is, information indicating that mutual understanding is not achieved is displayed on, for example, the display of the apparatus so that the user knows the result. Thereafter, the grounding process is continuously performed.

Note that the process shown in FIG. 5 is continuously and repeatedly performed during, for example, the execution of the grounding process until mutual understanding is achieved in step S106 or the grounding phase is completed.

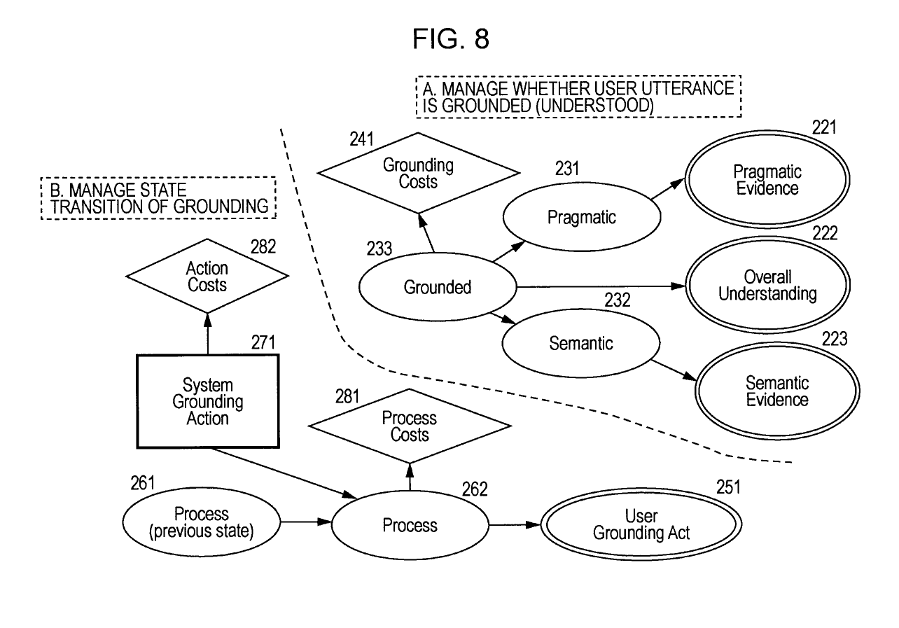

A process performed by the POMDP execution unit 200 of the discourse manager 101, that is, a process using a partially observable Markov decision process (POMDP) is described next with reference to FIG. 8.

The POMDP execution unit 200 executes the process using the POMDP that includes the following two processes:

(A) a management process for determining whether a user utterance is grounded (understood), and

(B) a management process of grounding phase transition.

FIG. 8 illustrates POMDP management information items for the two processes (A) and (B), that is, the following information items illustrated in FIG. 3:

(a) state apace (S),

(b) action space (A),

(c) observation space (O), and

(d) reward space (R).

Note that the POMDP is constructed by a Bayesian network having terminal nodes representing observation information (Observation). A Bayesian network is a network indicating the dependencies among probability variables in the form of a directed graph. For example, the directed graph includes nodes representing events and links representing a cause-and-effect relationship between the events. Through learning using sample learning data, conditional probability tables (CPTs) that indicate the probability of the occurrence of a node of the Bayesian network on the basis of a particular condition can be generated.

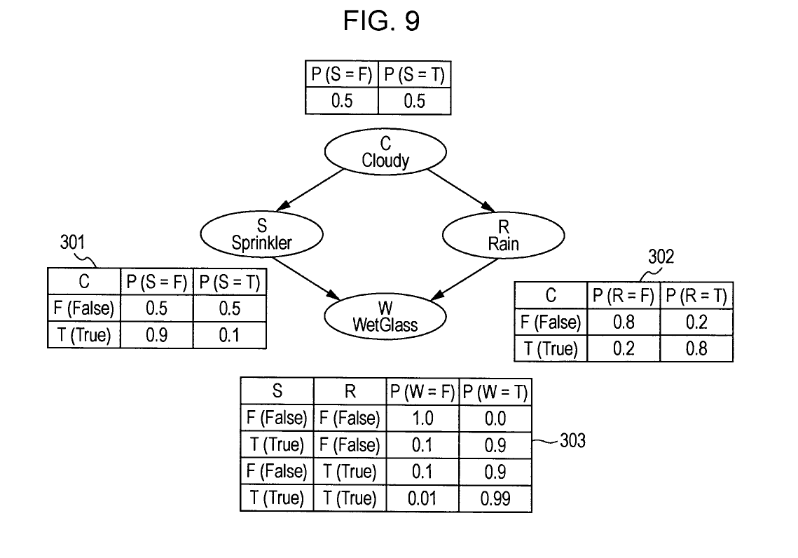

The Bayesian network and the conditional probability tables (CPTs) are described next with reference to FIG. 9. The Bayesian network is employed for stochastic reasoning. In particular, by using the Bayesian network, prediction or decision-making can be quantitatively handled in an area including uncertainty in which only some of events are observed. Basically, in this algorithm, a plurality of events are defined as nodes, and the dependencies among the nodes are modeled.

In an example shown in FIG. 9, four event nodes [Cloudy], [Sprinkler], [Rain], and [WetGlass] are defined as the nodes. An arrow that links the nodes indicates that the source of the arrow (a parent node) has an impact on the destination of the arrow (a child node).

In the example illustrated in FIG. 9, the node [Cloudy] has the probability of True=0.5 and the probability of False=0.5.

In such a case, for the child node [Sprinkler] of the parent node [Cloudy], the probability of Sprinkler being on (True) and the probability of Sprinkler being off (False) can be obtained in the form of CPTs (conditional probability tables) in accordance with the state of the parent node [Cloudy]. That is, a CPT 301 shown in FIG. 9 can be obtained.

The CPT 301 indicates that, when the parent node [Cloudy]=F (False),

the probability of the child node [Sprinkler] being off (False)=0.5 and

the probability of the child node [Sprinkler] being on (True)=0.5, and when the parent node [Cloudy]=T (True),

the probability of the child node [Sprinkler] being off (False)=0.9 and

the probability of the child node [Sprinkler] being on (True)=0.1.

In the CPT 301, P(S=F) represents the probability (Feasibility) of the child node [Sprinkler] being False, and P(S=T) represents the probability (Feasibility) of the child node [Sprinkler] being True.

In addition, for the child node [Rain] of the parent node [Cloudy], the probability of Rain being raining (True) and the probability of Rain being not raining (False) can be obtained in the form of CPTs (conditional probability tables) in accordance with the state of the parent node [Cloudy]. That is, a CPT 302 shown in FIG. 9 can be obtained.

The CPT 302 indicates that, when the parent node [Cloudy]=F (False),

the probability of the child node [Rain] being not raining (False)=0.8 and

the probability of the child node [Rain] being raining (True)=0.2, and when the parent node [Cloudy]=T (True),

the probability of the child node [Rain] being not raining (False)=0.2 and

the probability of the child node [Rain] being raining (True)=0.8.

Furthermore, for the child node [WetGlass] of the parent nodes [Sprinkler] and [Rain], the probability of Grass being wet (True) and the probability of Grass being not wet (False) can be obtained in the form of CPTs (conditional probability tables) in accordance with the states of the parent nodes [Sprinkler] and [Rain]. That is, a CPT 303 shown in FIG. 9 can be obtained.

The CPT 303 indicates that, when the parent node [Sprinkler]=F (False) and the parent node [Rain]=F (False),

the probability of the child node [WetGlass] being not wet (False)=1.0 and

the probability of the child node [WetGlass] being wet (True)=0.0, and when the parent node [Sprinkler]=T (True) and the parent node [Rain]=F (False),

the probability of the child node [WetGlass] being not wet (False)=0.1 and

the probability of the child node [WetGlass] being wet (True)=0.9 and, when the parent node [Sprinkler]=F (False) and the parent node [Rain]=T (true),

the probability of the child node [WetGlass] being not wet (False)=0.1 and

the probability of the child node [WetGlass] being wet (True)=0.9, and when the parent node [Sprinkler]=T (True) and the parent node [Rain]=T (True),

the probability of the child node [WetGlass] being not wet (False)=0.01 and

the probability of the child node [WetGlass] being wet (True)=0.99.

In this way, a conditional probability table (CPT) indicates the probabilities of the occurrences of the results of the child nodes in the form of a table indicating the distribution of the probabilities that depend on the probability of the condition of the parent node. By employing a Bayesian network in this manner, a CPT representing a table of the conditional probability that indicates that a result is obtained if a cause appears can be obtained.

In the configuration according to the present invention, the dependencies among the elements included in the following information items illustrated in FIG. 3 are expressed using a Bayesian network:

(a) state apace (S),

(b) action space (A),

(c) observation space (O), and

(d) reward space (R).

Thereafter, the POMDP shown in FIG. 8 is set. The POMDP execution unit 200 executes the process using the POMDP that includes the following two processes:

(A) a management process for determining whether a user utterance is grounded (understood), and

(B) a management process of grounding phase transition.

Node information items shown in FIG. 8 are described below. In the management process (A) for determining whether a user utterance is grounded (understood), the observation space includes the following three observation spaces: Pragmatic evidence 221, Overall Understanding 222, and Semantic Evidence 223.

The state space includes the following three state spaces: Pragmatic 231, Semantic 232, and Grounded 233.

Furthermore, Grounding Cost 241 is set as the reward space.

The pragmatic evidence 221 included in the observation space can be obtained on the basis of, for example, the feasibility of the task obtained from the task manager 103 through the processes in steps S202 and S203 of the flow shown in FIG. 6. For example, as described earlier, a high confidence [H(High)], a low confidence [L(Low)], or a medium confidence [A(Ambiguous)] can be obtained. Note that various types of information may be obtained. For example, two types of observation space (Yes, No) may be set in accordance with the feasibility of the task.

In addition, Overall Understanding 222 included in the observation space includes various information in addition to the observation spaces obtained from the observation spaces 241 and 243. For example, the overall Understanding 222 includes observation spaces regarding the state of conversation with the user that outputs the utterance, the state indicating whether the user answered the question output from the system, and information as to whether a user is present or not.

In accordance with the observation spaces, the above-described observation spaces, such as [H(High)], [L(Low)], [A(Ambiguous)], or (Yes, No) can be obtained.

Furthermore, the semantic Evidence 223 included in the observation space represents the result of the speech recognition and semantic analysis performed on the user utterance.

For example, an observation space indicating [H(High)], [L(Low)], [A(Ambiguous)], or (Yes, No) in accordance with whether the semantic analysis is successful or not can be obtained.

For Pragmatic 231 included in the state space and including the feasibility of a task, a state value based on the analysis information in the pragmatic evidence 221 included in the observation space is set.

For example, the state of [H(High)], [L(Low)], or [A(Ambiguous)] is set, or (Yes, No) are set using probability values in accordance with whether the feasibility of the task is present. When two states, such as (Yes, No), are used, probability value data (the probability of Yes [0.8] and the probability of No [0.2]) are set, for example.

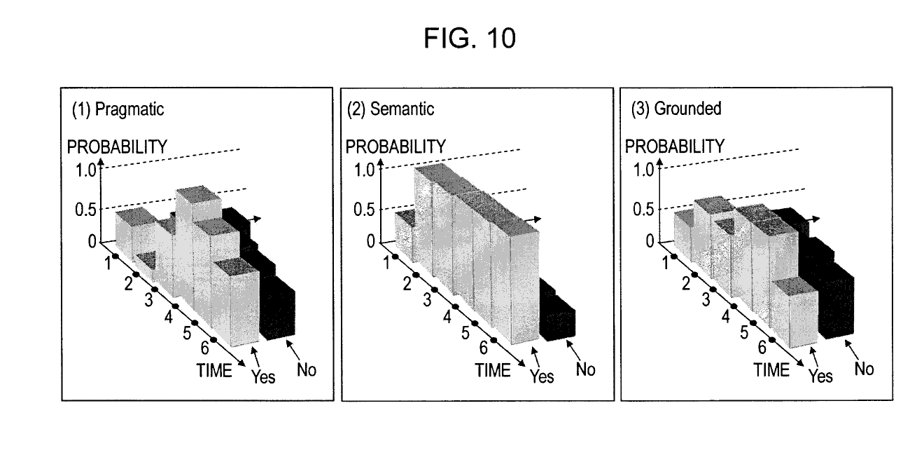

FIG. 10(1) illustrates an example of transition of the state value data of the pragmatic 231 as time passes. The probability value of [Yes] and the probability value of [No] change in accordance with input of the pragmatic evidence 221 as time passes.

Furthermore, for the semantic 232 included in the state space, a state value based on the analysis information in the semantic Evidence 223 included in the observation space is set.

For example, two states (Yes, No) are set using probability values in accordance with the observation space indicating whether the semantic analysis is successful or not. For example, the probability of Yes [0.9] and the probability of No [0.1]) are set.

FIG. 10(2) illustrates an example of transition of the state value data of the semantic 232 as time passes. The probability value of [Yes] and the probability value of [No] change in accordance with input of the observation information (the semantic evidence 223) as time passes.

Furthermore, for the grounded 233 included in the state space, observation information obtained from the pragmatic 231 including the feasibility of the task included in the task space, information on the semantic 232, and the overall Understanding 222 is set. For example, an integrated state value based on a conversation state of the user who outputs the utterance, information as to whether the user responded to a question output from the user, information as to whether a user is present is set.

For example, two states (Yes, No) indicating whether understanding is achieved are set using the probability values. For instance, the probability of Yes [0.7] and the probability of No [0.3]) are set.

FIG. 10(3) illustrates an example of transition of the state value data of the grounded 233 as time passes. The probability value of [Yes] and the probability value of [No] change in accordance with input of the pragmatic 231 generated using the task feasibility information, information on the semantic 232, and the overall Understanding 222 as time passes.

The grounding Cost 241 set as Reward space corresponds to a cost for execution of the grounded 233 included in the state space. For example, the cost varies when sufficient understanding is obtained through a grounding process and a correct process can be performed or when sufficient understanding is not finally obtained and time is wasted.

In addition, in the management process (B) for managing grounding phase transition, the observation space includes User Grounding Act 251.

The state space includes the following two state spaces: a Process previous state 261 and a process 262.

The Action space includes a System Grounding Action 271 performed by the information processing apparatus.

Furthermore, as the Reward space, the following two reward spaces: Process Costs 281 and Action costs 282 are set.

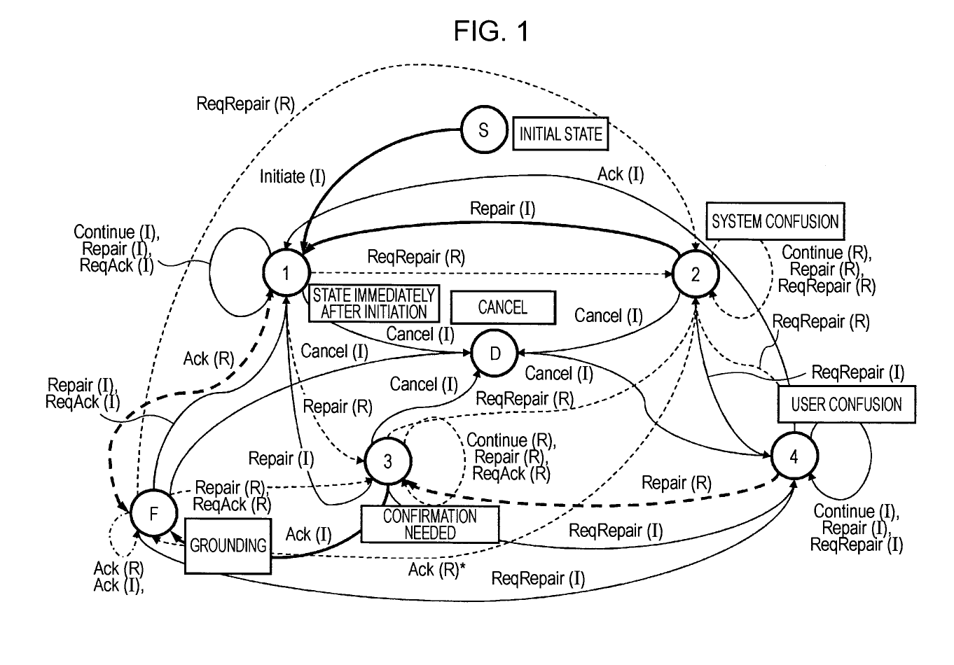

The user Grounding Act 251 included in the observation space represents information regarding a user action performed in the grounding process. More specifically, for example, in the grounding model illustrated in FIGS. 1 and 2, the following observation spaces can be obtained as a user action:

an utterance initiation process (Initiate),

a continuation process (continue),

a confirmation process (repair),

a confirmation requesting process (RegRepair),

an acknowledgement response (ack),

a request for an acknowledgement response (Reqack), and

cancel (cancel).

The process previous state 261 and the process 262 included in the state space correspond to two time-series execution process states in the grounding action. For example, in the grounding model illustrated in FIGS. 1 and 2, as the state values of the process previous state 261 and the process 262, the probability values for the seven states S, 1, 2, 3, 4, D, and F are set, where
S: an initial state,
1: a state immediately after an initiation,
2. system confusion,
3. confirmation needed,
4. user confusion,
D. cancel
F. grounding completion.

At that time, the probability values for the seven states S to F are set so that the sum of the probability values of the state S to F is [1].

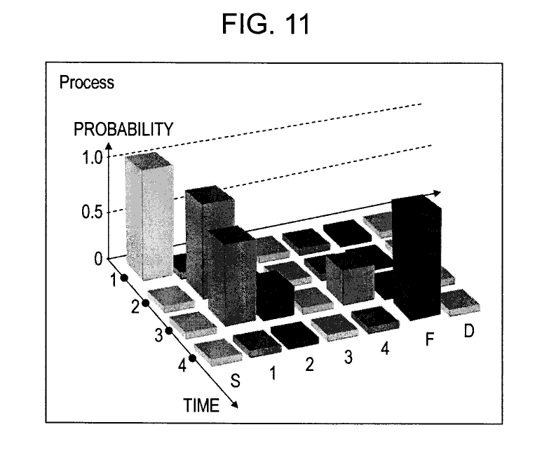

FIG. 11 illustrates an example of transition of the state value data of the process 262 as time passes. The probability values corresponding to the states S to F change in accordance with input of the user Grounding Act 251 as time passes.

The System Grounding Action 271 included in the action space represents a grounding action performed by the information processing apparatus for mutual understanding. The system Grounding Action 271 is a process performed in the system. In the grounding model illustrated in FIGS. 1 and 2, the following actions are executed by the system:

an utterance initiation process (Initiate),

a continuation process (continue),

a confirmation process (repair),

a confirmation requesting process (RegRepair),

an acknowledgement response (ack),

a request for an acknowledgement response (Reqack), and

cancel (cancel).

Process Costs 281 set as Reward space corresponds to an execution cost of the process 262 included in the state space. For example, the cost is set so as to vary in accordance with the time required for the process and the processing load.

Action Costs 282 set as Reward space corresponds to an execution cost of the system Grounding Action 271 included in the action space. For example, the action Costs 282 are set so as to vary in accordance with the time required for the process and the processing load.

The system Grounding Action 271 shown in FIG. 8 corresponds to the action space in the POMDP. The system Grounding Action 271 represents a grounding action performed by the information processing apparatus for mutual understanding.

In the grounding model illustrated in FIGS. 1 and 2, one of the following actions is executed by the system:

an utterance initiation process (Initiate),

a continuation process (continue),

a confirmation process (repair),

a confirmation requesting process (RegRepair),

an acknowledgement response (ack),

a request for an acknowledgement response (Reqack), and

cancel (cancel).

Which one of the actions is to be executed is determined in accordance with the cost computed using a cost computing algorithm set in the POMDP.

In the grounding model illustrated in FIGS. 1 and 2, an action executed by the system is one of the above-described seven actions (Initiate to cancel). However, as mentioned earlier, the grounding model illustrated in FIGS. 1 and 2 is only an example. Accordingly, a grounding model having a different configuration can be used.

For example, a simplified grounding model having only three actions: an utterance initiation process (Initiate), an acknowledgement response (ack), and a cancel (cancel) may be used.

For example, a grounding model generated by removing, from the grounding model shown in FIG. 1, the actions other than the following three actions: an utterance initiation process (Initiate), an acknowledgement response (ack), and cancel (cancel) can be used. In addition, some of the phases S, 1, 2, 3, 4, F, and D shown in FIG. 1 may be removed.

An example of processing using a simplified grounding model in which only three actions: an utterance initiation process (Initiate), an acknowledgement response (ack), and a cancel (cancel) are defined is described below.

An example in which an apparatus that executes a grounding process using the POMDP is an apparatus including a television set and a user requests the apparatus to change a television channel is described next.

When the user makes a request to the apparatus using words “Change the television channel to 1”, the semantic parser emulator 105 shown in FIG. 4 analyzes the meaning of the words.

If, for example, the semantic parser emulator 105 does not sufficiently recognize the user utterance, a grounding process is performed. In such a case, the grounding act emulator 106 extracts the user action and the utterance information as a grounding act, which is output to the discourse manager 101 together with the user utterance information.

Upon receiving the information from the grounding act emulator 106, the discourse manager 101 performs a grounding process, that is, a grounding process for achieving mutual understanding with the user. In the grounding process, the POMDP is employed.

In the grounding process, for example, a question is displayed on the display 102. The answer to the question is input by the user 20 through the user interface (the GUI front-end) 104. The semantic parser emulator 105 performs language analysis including speech recognition and semantic analysis. The grounding act emulator 106 extracts a grounding act. The information regarding the result is input to the discourse manager 101. In the grounding process, such processing is repeated.

When the user sends a request “Change the television channel to 1” to the apparatus, the discourse manager 101 asks the question by displaying the message “Channel 1?” on the display 102.

The possible answer from the user is one of the following three:

(a) Yes,

(b) No, and

(c) Else.

The discourse manager 101 determines an action to be performed in accordance with one of the three answers. For example, if (A) the answer from the user is “Yes”, an action to be performed (a grounding act)=an acknowledgement response (ack). However, if (B) the answer from the user is “No”, an action to be performed (a grounding act)=cancel. If (c) the answer from the user is “Else”, an action to be performed (a grounding act)=Initiate.

An algorithm for determining the action to be performed (a grounding act) is expressed as follows:

If Answer is YesNoAnswer
If Answer is Negative
   GroundingAct=Cancel
Else
   GroundingAct=Ack

Else
GroundingAct=Initiate

Note that if the action to be performed (GroundingAct)=Initiation of action (Initiate), a user utterance is further received and, subsequently, a new grounding process is started. In this way, the number of actions may be limited (three in this example), and a simplified grounding model may be applied to the process.

As described above, according to the present invention, in the grounding process, a variety of grounding models can be employed. In addition, the process using the POMDP can be performed. Consequently, mutual understanding between the user and the information processing apparatus can be efficiently achieved.

[(4) Exemplary Grounding Process using POMDP]

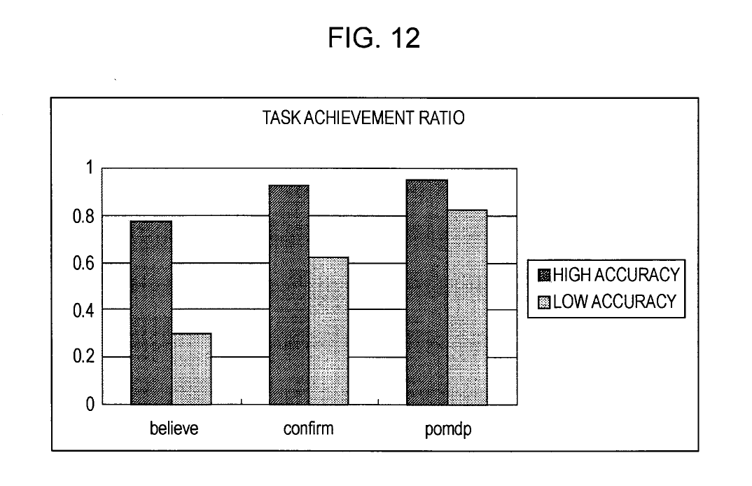

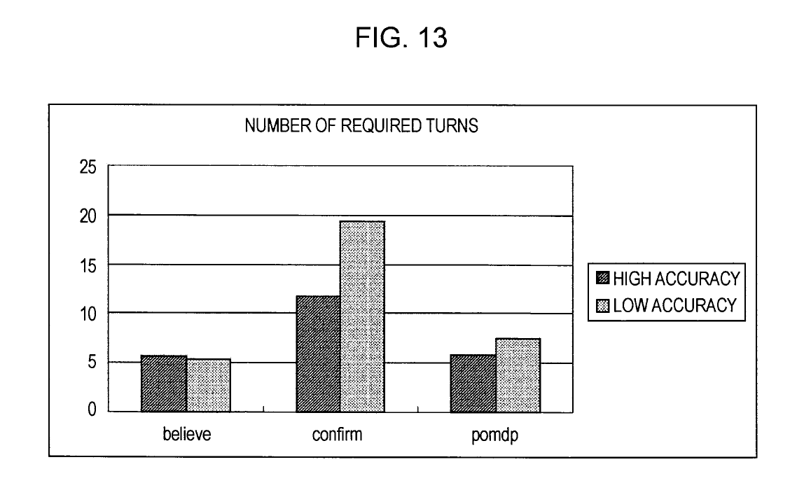

Evaluation data regarding the grounding process using the POMDP according to the present invention is described next with reference to FIG. 12 and the subsequent drawings. FIGS. 12 and 13 are diagrams illustrating a comparison of the results of the grounding process using the POMDP according to the present invention and a grounding process without the POMDP.

First, as a task, a user requests a system (a television set, that is, an information processing apparatus) to display a television program. For example, the user makes the request “I want to view a sports program”, and discourse is initiated. Finally, the sports program that the user wants to view is displayed. The comparison is made using such a process.

The following processes are compared:

(1) believe: a process in which the system trusts all the words received from the user,

(2) confirm: a process in which the system confirms user words every time the system receives the user words, and

(3) POMDP: a process using the POMDP according to the present invention.

Evaluation is carried out using the following two indices:

(A) the task achievement ratio:the ratio of successful selection of a program to be selected, and

(B) the number of turns: the number of user utterances required until the program to be selected is selected.

Each of four users performs processes to select 10 programs. The results of the evaluations (A) and (B) obtained from the total of 40 processes through the processes (1) to (3) are shown in FIGS. 12 and 13. Note that the results of the processes obtained when two systems having a high accuracy of the language processing and a low accuracy of the language processing are employed are shown.

FIG. 12 illustrates (A) the task achievement ratio (the ratio of successful selection of a program to be selected) for the following processes:

(1) believe (a process in which the system trusts all of the user words),

(2) confirm (a process in which the system asks for confirmation of the user words at all times), and

(3) POMDP (a process using the above-described POMDP).

As can be seen from FIG. 12, the task achievement ratio is the highest for the process using the POMDP. That is, an excellent result is obtained, as compared with the other results.

FIG. 13 illustrates (B) the number of turns (the number of user utterances required until the program to be selected is selected) for the following processes:

(1) believe (a process in which the system trusts all of the user words),

(2) confirm (a process in which the system asks for confirmation of the user words at all times), and

(3) POMDP (a process using the above-described POMDP).

As can be seen from FIG. 13, the number of turns is the lowest for [believe], that is, the process in which the system trusts all of the user words. However, the process using the POMDP can be completed with the same number of turns as for [believe].

For [believe], that is, the process in which the system trusts all of the user words, the task achievement ratio shown in FIG. 12 is low. As a result, in terms of the task achievement ratio and the number of turns, the process using the POMDP according to the present invention is superior to the other processes.

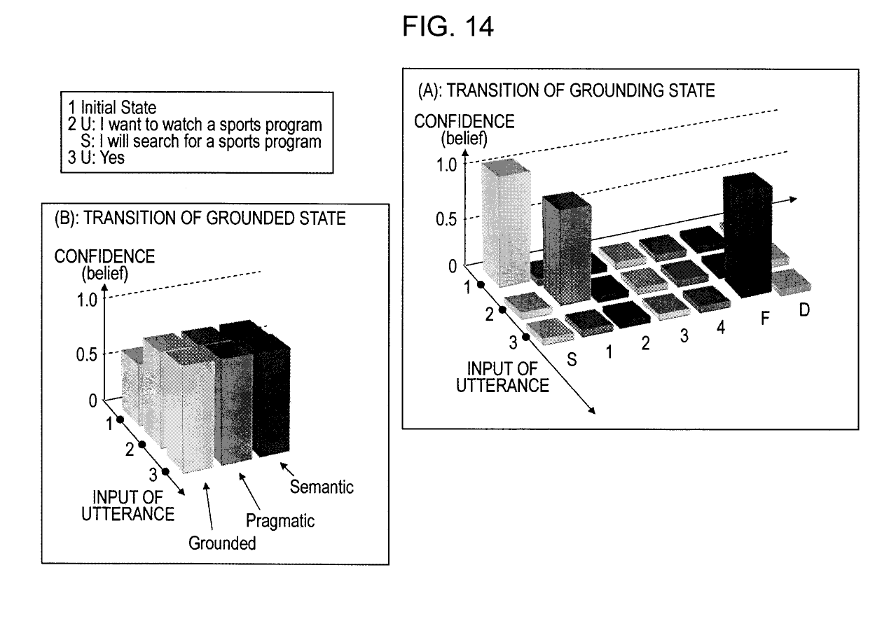

Examples of the grounding place using the POMDP are described next with reference to FIGS. 14 to 17. FIGS. 14 to 17 respectively illustrate the following cases:

(1) the case in which the user sufficiently communicates with the system (FIG. 14),

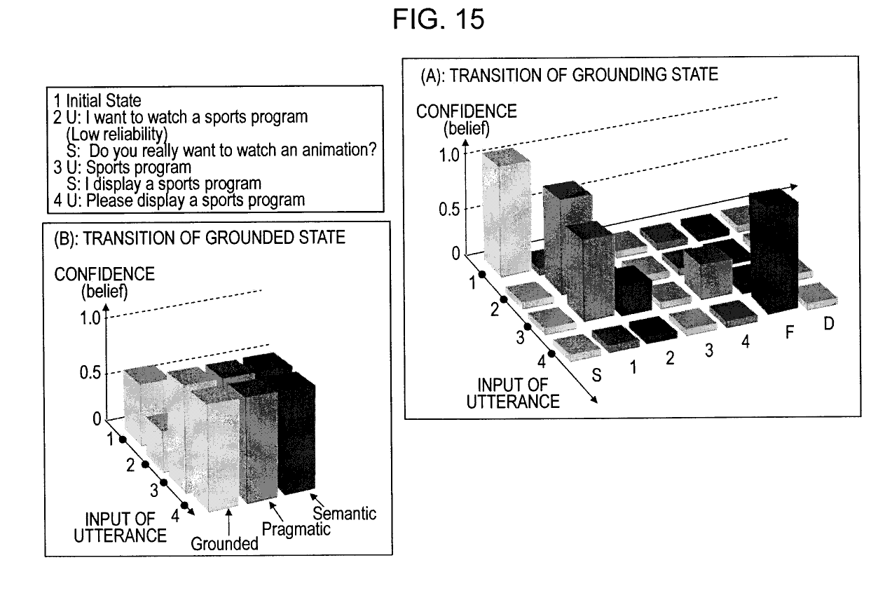

(2) the case in which a request of the user is ambiguous (a request has low reliability) (FIG. 15),

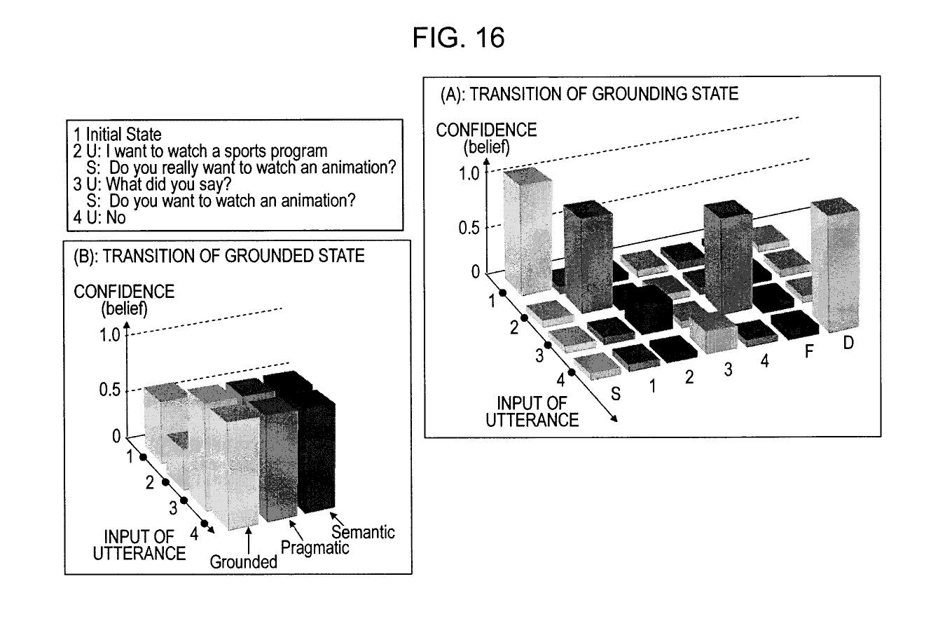

(3) the case in which the system incorrectly understood a request from the user (FIG. 16), and

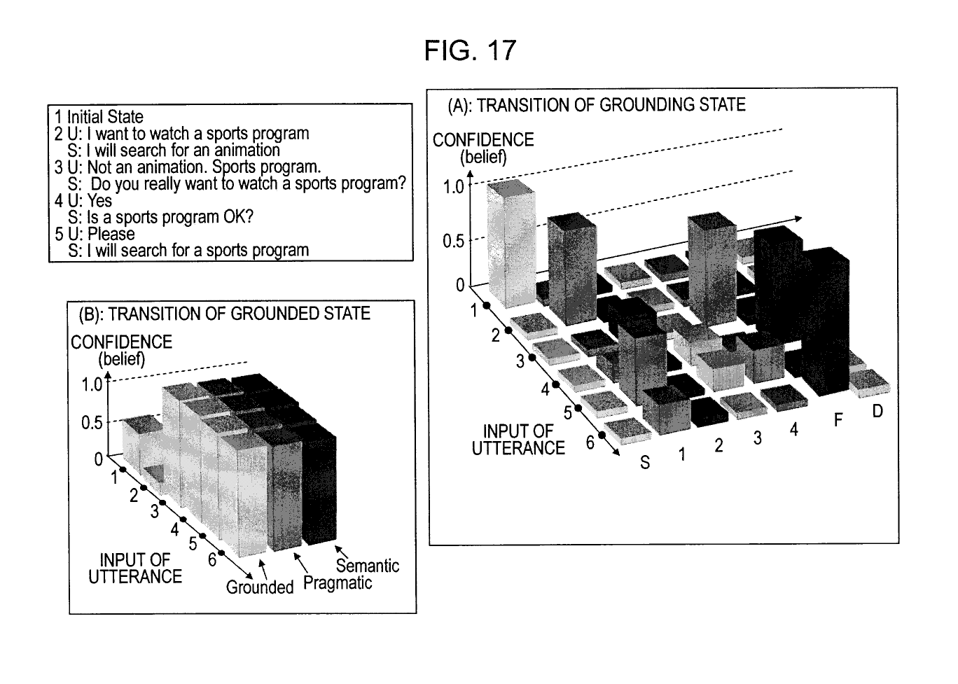

(4) the case in which communication between the user and the system is long (FIG. 17).

In FIGS. 14 to 17, a sequence of questions between the user and the system (the information processing apparatus) and transition data: (A) transition of a grounding state and (B) transition of a grounded state are illustrated as transition data for the user utterances.

The grounding transition state (A) corresponds to the process 262 in the POMDP shown in FIG. 8, and the grounded transition state (A) corresponds to the probability value of [Yes] of the grounded 233, the pragmatic 231 generated using information, such as task feasibility, and the semantic 232 in the POMDP shown in FIG. 8.

Each of FIGS. 14 to 17 is described below.

(1) Case in which User Sufficiently Communicates with System

FIG. 14 illustrates the case in which the user sufficiently communicates with the system. In this case, for example, the grounding transition state (A) is successfully changed from S (an initial state) to F (Grounding) via 1 (a state immediately after an initiation). Thus, grounding, that is, mutual understanding between the user and the system is achieved.

In transition of a grounded state (B), the probability value of [Yes] of each of the grounded 233, the pragmatic 231, and the semantic 232 is higher than that at the time of second input of an utterance. Thus, a state in which the request from the user is almost understood appears.

(2) Case in which Request of User is Ambiguous (Request has Low Reliability)

FIG. 15 illustrates the case in which a request of the user is ambiguous (a request has low reliability). In this case, a problem in which the system cannot clearly hear the second input of the utterance of the user “I want to watch a sports program” arises. The system then asks a confirmation question “Do you really want to watch an animation?”

In such a case, the grounding state transition (A) is as follows:

S (an initial state)->1 (a state immediately after an initiation)->(1 (a state immediately after an initiation)≅0.6, 2 (system confusion)≅0.1, 4 (user confusion)≅0.3)->F (grounding)

In user utterances 2 and 3, the user grounding, that is, understanding between the user and the system enters a confusion state.

For (B) grounded state transition, the confidence levels of [Yes] of the grounded 233, the pragmatic 231, and the semantic 232 are temporarily decreased at a time of input of the second utterance. Thereafter, at a time of input of the third utterance, the confidence levels of [Yes] are decreased. Thus, a state in which it is almost always believed that the request from the user is understood appears.

(3) Case in which System Incorrectly Understood Request from User

FIG. 16 illustrates the case in which the system incorrectly understood a request from the user. In this case, a problem in which the system cannot clearly hear the input of the second utterance of the user “I want to watch a sports program” arises. The system asks the user “Do you really want to watch an animation?” to confirm the utterance. Furthermore, the user cannot hear the question and produces the input utterance “What did you say?”. Still furthermore, in response to the utterance, the system asks the user “Do you want to watch an animation?” In response to the question, the user makes a negative answer “No”.

In such a case, the grounding state transition (A) is as follows:

S (an initial state)->1 (a state immediately after an initiation)->(2 (system confusion)≅0.2, 4 (user confusion)≅0.8)->(3 (confirmation needed)≅0.2, D (cancel)≅0.8)

Thus, the user grounding, that is, understanding between the user and the system is not achieved, and a cancel state is reached.

For (B) grounded state transition, the confidence levels of [Yes] of the grounded 233, the pragmatic 231, and the semantic 232 are decreased at a time of input of the second utterance. Thereafter, the confidence level is recovered and, therefore, a significant problem regarding the analysis information does not arise.

(4) Case in which Communication Between User and System is Long

FIG. 17 illustrates the case in which communication between the user and the system is long. Grounding is achieved by input of utterances 1 to 5 from the user.

In this case, for example, (A) the grounding state transition is as follows:

S (an initial state)->1 (a state immediately after an initiation)-> . . . ->F (grounding)

That is, through a plurality of states in accordance with the number of the utterances of the user, a grounding state is reached. Finally, the user grounding, that is, understanding between the user and the system is achieved.

For (B) grounded state transition, the confidence levels of [Yes] of the grounded 233, the pragmatic 231, and the semantic 232 are increased at a time of input of the second utterance. Thus, a significant problem regarding the analysis information does not arise.

### [(5) Exemplary Hardware Configuration of Information Processing Apparatus]

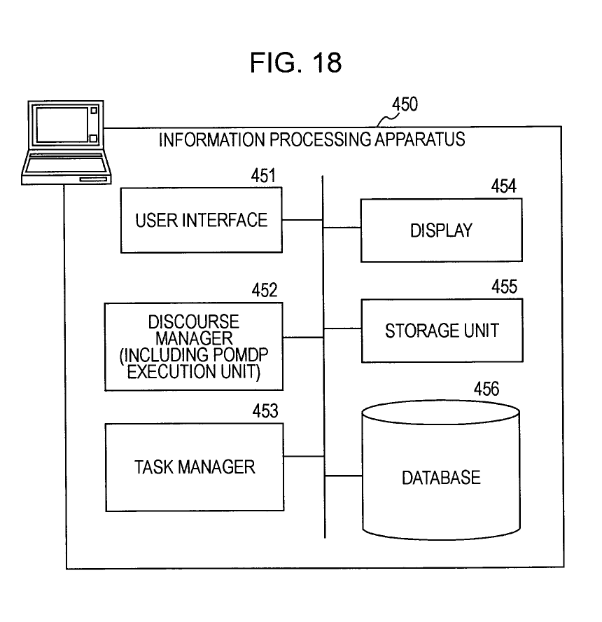

An exemplary hardware configuration of the information processing apparatus that performs a grounding process using the above-described POMDP is described next with reference to FIG. 18. An information processing apparatus 450 is realized by a variety of information processing apparatuses having a program execution function, such as a widely used PC or a television set having a CPU serving as a program execution unit. Note that a particular example of the hardware configuration is described below.

The information processing apparatus 450 includes a user interface 451, a discourse manager 452 that performs a grounding process using the POMDP, a task manager 453, a display 454, a storage unit 455, and a database 456. The user interface 451, the discourse manager 452, the task manager 453, and the display 454 have the configurations illustrated in FIG. 4.

For example, when an utterance is input from a user through the user interface 451, a grounding process using the POMDP is performed by the discourse manager 452. The discourse manager 452 performs the grounding process using the POMDP illustrated in FIGS. 4 to 8. The task manager 452 manages tasks performed in the information processing apparatus 450. The detailed processing is the same as that illustrated in FIG. 4.

Note that the database 456 stores programs applied to the POMDP, computing functions used for generating the cost computing algorithm and computing the state transition probability applied to the POMDP, a computing function of a reward, a function of computing the probability of the occurrence of a given observation state, and data for a question rule. The storage unit 454 is formed from a memory serving as a storage area of the parameters of various data processing and programs and a work area.

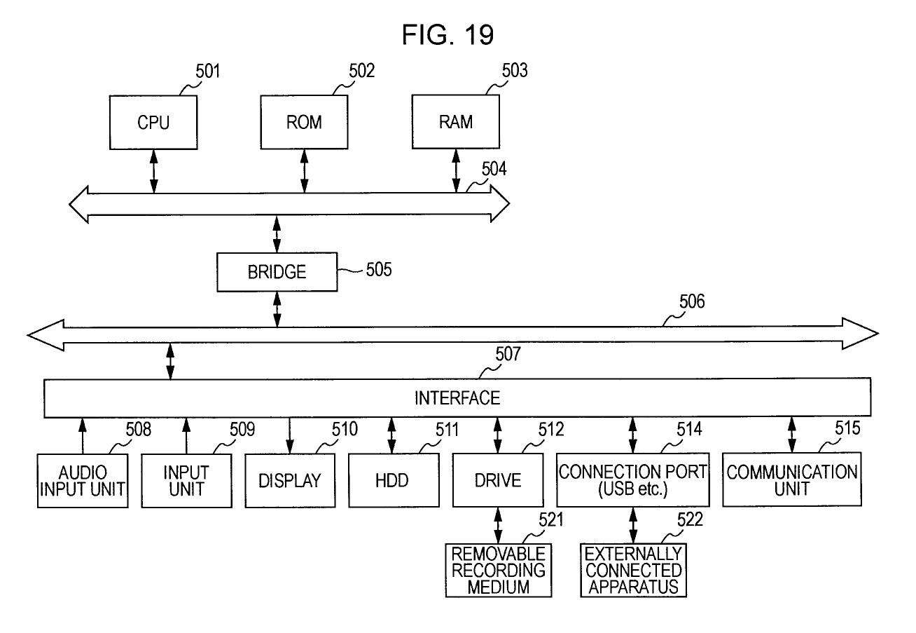

Finally, an example of the hardware configuration of the information processing apparatus that performs the above-described processing is described with reference to FIG. 19. A CPU (Central Processing Unit) 501 functions as a main portion of the data processing unit described in the above-described embodiment and performs a process corresponding to the OS (Operating System). More specifically, the CPU 501 performs the grounding process using the POMDP and a task management process. These processes are performed in accordance with the computer programs stored in the data storage unit, such as a ROM and a hard disk of each information processing apparatus.

A ROM (Read Only Memory) 502 stores the programs used by the CPU 501, a POMDP generation program, and computation parameters. A RAM (Random Access Memory) 503 stores the programs executed by the CPU 501 and parameters that vary in the execution of the programs as needed. These are connected to one another using a host bus 504 formed from, for example, a CPU bus.

The host bus 504 is connected to an external bus 506 (e.g., a PCI (Peripheral Component Interconnect/Interface) bus) via a bridge 505.

An audio input unit 508 receives an utterance of a user. An input unit 509 is formed from an input device that is operated by the user. A display 510 is formed from a liquid crystal display device or a CRT (Cathode Ray Tube).

An HDD (Hard Disk Drive) 511 include a hard disk. The HDD 511 drives the hard disk so that the programs to be executed by the CPU 501 and information are recorded or reproduced. The hard disk serves as storage means for storing a rule applied to POMDP generation. Furthermore, the hard disk stores various computer programs, such as a data processing program.

A drive 512 reads data or a program stored in a removable recording medium 521 (e.g., a mounted magnetic disk, optical disk, magneto-optical disk, or semiconductor memory). Thereafter, the drive 512 supplies the data or the program to the RAM 503 connected thereto via an interface 507, the external bus 506, a bridge 505, and the host bus 504.

A connection port 514 serves as a port to which an externally connected apparatus 522 is connected. The connection port 514 includes a connection unit, such as USB or IEEE 1394. The connection port 514 is connected to, for example, the CPU 501 via the interface 507, the external bus 506, the bridge 505, and the host bus 504. A communication unit 515 is connected to a network.

Note that the example of the hardware configuration of the information processing apparatus shown in FIG. 19 is formed using a PC. However, the configuration is not limited to the configuration shown in FIG. 19. For example, a variety of apparatuses that can perform the processing described in the foregoing embodiment can be employed.

While the present invention has been described in the context of specific embodiments thereof, other alternatives, modifications, and variations will become apparent to those skilled in the art within the scope of the present invention. Accordingly, the above disclosure is not intended to be limiting and the scope of the present invention should be determined by the appended claims and their legal equivalents.

In addition, the above-described series of processes can be executed by hardware, software, or a combinational configuration thereof. When the above-described series of processes are executed by software, the programs that record the processing sequence can be installed in a memory of a computer incorporated in dedicated hardware and can be executed. Alternatively, the programs can be installed in a general-purpose computer that can execute a variety of function and can be executed. For example, the programs can be prerecorded in a recording medium. The programs can be installed in a computer from the recording medium. In addition, the programs are received via a network, such as a LAN (Local Area Network) or the Internet and can be installed in a recording medium, such as a hard disk, incorporated in a computer.

In the present specification, the various processes are performed in the above-described sequence. However, the processes may be executed in parallel or independently in accordance with the processing power or processing capability of the apparatus that performs the processes or as needed. In addition, as used in the present specification, the term “system” refers to a logical combination of a plurality of devices; the plurality of devices is not necessarily included in one body.

### INDUSTRIAL APPLICABILITY

As described above, according to an embodiment of the present invention, the configuration is designed so that, in order to understand a request from a user through the utterances from the user, a grounding process is performed using the POMDP (Partially Observable Markov Decision Process) in which analysis information acquired from a language analyzing unit that receives the utterances of the user and performs language analysis and pragmatic information including task feasibility information acquired from the task manager that performs a task are set as observation information. Accordingly, understanding can be efficiently achieved, and high-speed and accurate recognition of the user request and task execution based on the user request can be provided.

1. An information processing apparatus for receiving an utterance from a user and analyzing the utterance, characterized by comprising:
a user interface that receives an utterance from a user and performs language analysis;
a discourse manager that receives a recognition result of information regarding the user utterance input via the user interface and performs a grounding process for understanding a user request by using a Partially Observable Markov Decision Process (POMDP); and
a task manager that executes a task on the basis of information regarding a result of the grounding process performed by the discourse manager.

2. The information processing apparatus according to claim 1, characterized by further comprising:
a display that displays a system action for the user during the grounding process performed by the discourse manager.

3. The information processing apparatus according to claim 1, characterized in that the discourse manager has a configuration so as to perform a grounding process using the POMDP in which semantic information generated from the utterance from the user and pragmatic information generated on the basis of information including feasibility of a task performed by the task manager are set as Observation space.

4. The information processing apparatus according to claim 3, characterized in that the discourse manager has a configuration so as to perform a grounding process using the POMDP in which a state value computed using the semantic information serving as an observation space and a state value computed using the pragmatic information serving as Observation space are set as State space.

5. The information processing apparatus according to claim 3, characterized in that the discourse manager has a configuration so as to perform a grounding process using the POMDP in which a state value computed using the semantic information serving as Observation space, a state value computed using the pragmatic information serving as Observation space, and a state value computed using another observation space are set as State space.

6. The information processing apparatus according to claim 3, characterized in that the discourse manager has a configuration so as to perform a grounding process using the POMDP having a configuration in which a cost is computed on the basis of State space including a state value computed using the semantic information serving as Observation space and a state value computed using the pragmatic information serving as Observation space.

7. The information processing apparatus according to claim 1, characterized in that the discourse manager has a configuration so as to perform a grounding process using the POMDP in which a user action including the utterance from the user is set as Observation space.

8. The information processing apparatus according to claim 7, characterized in that the discourse manager has a configuration so as to perform a grounding process using the POMDP in which a state value computed using the user action serving as Observation space is set as State space.

9. An information processing method for use in an information processing apparatus for receiving an utterance from a user and analyzing the utterance, characterized by comprising:
a language input and analysis step of receiving an utterance from a user and performing language analysis by using a user interface;
a discourse management step of receiving a recognition result of information regarding the user utterance input via the user interface and performing a grounding process for understanding a user request by using a Partially Observable Markov Decision Process (POMDP) by using a discourse manager; and
a task management step of executing a task on the basis of information regarding a result of the grounding process performed in the discourse management step by using a task manager.

10. The information processing method according to claim 9, characterized by further comprising:
a step of displaying a system action for the user during the grounding process performed in the discourse management step by using a display.

11. The information processing method according to claim 9, characterized in that the discourse management step is a step of performing a grounding process using the POMDP in which semantic information generated in response to the utterance from the user and pragmatic information generated on the basis of information including feasibility of a task performed by the task manager are set as Observation space.

12. The information processing method according to claim 11, characterized in that the discourse management step is a step of performing a grounding process using the POMDP in which a state value computed using the semantic information serving as an observation space and a state value computed using the pragmatic information serving as Observation space are set as State space.

13. The information processing method according to claim 11, characterized in that the discourse management step is a step of performing a grounding process using the POMDP in which a state value computed using the semantic information serving as Observation space, a state value computed using the pragmatic information serving as Observation space, and a state value computed using another observation space are set as State space.

14. The information processing method according to claim 11, characterized in that the discourse management step is a step of performing a grounding process using the POMDP having a configuration in which a cost is computed on the basis of State space including a state value computed using the semantic information serving as Observation space and a state value computed using the pragmatic information serving as Observation space.

15. The information processing method according to claim 9, characterized in that the discourse management step is a step of performing a grounding process using the POMDP in which a user action including the utterance from the user is set as Observation space.

16. The information processing method according to claim 15, characterized in that the discourse management step is a step of performing a grounding process using the POMDP in which a state value computed using the user action serving as Observation space is set as State space.

17. The information processing method according to claim 15, characterized in that the discourse management step is a step of performing a grounding process using the POMDP having a configuration in which a cost is computed on the basis of State space including a state value computed using the user action serving as Observation space.

18. The information processing method according to claim 9, characterized in that the discourse management step is a step of performing a process using a grounding model in which an Initiate process, a continue process, a repair process, a RegRepair process, an ack process, a Reqack process, and a cancel process are defined as executed actions of the grounding process.

19. The information processing method according to claim 9, characterized in that the discourse management step is a step of performing a process using a grounding model in which an Initiate process, an ack process, and a cancel process are defined as executed actions of the grounding process.

20. A computer program for causing an information processing apparatus to perform information processing for receiving an utterance from a user and analyzing the utterance, characterized by comprising:
a language input and analysis step of receiving an utterance from a user and performing language analysis by using a user interface;
a discourse management step of receiving a recognition result of information regarding the user utterance input via the user interface and performing a grounding process for understanding a user request by using a POMDP (Partially Observable Markov Decision Process) by using a discourse manager; and
a task management step of executing a task on the basis of information regarding a result of the grounding process performed in the discourse management step by using a task manager.
